(19) United States
(12) Patent Application Publication
(10) Pub. No.: US 2009/0319648 A1
(43) Pub. Date: Dec. 24, 2009

(54) Branded Advertising Based Dynamic Experience Generator

(75) Inventors: Partha Dutta, Saratoga, CA (US); John Waclawsky, Bartlett, IL (US); Nino Vidovic, Saratoga, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: MOBILE TRIBE LLC, Redwood City, CA (US)

(21) Appl. No.: 12/490,261

(22) Filed: Jun. 23, 2009

Related U.S. Application Data
(60) Provisional application No. 61/075,093, filed on Jun. 24, 2008.

(51) Int. Cl. G06F 15/177

(52) U.S. Cl. 709/221

(57) ABSTRACT

Methods and apparatus are provided to provide served ads to one or more clients based on dynamic-community information, ad-related information, service features, service activity, country of origin, and device-related information. Dynamic communities are formed based on a trigger, which may be a command, a request for information, a change in context, or an event notification. After receiving the trigger, a served ad may be piggybacked onto a response to the trigger. The served ad may include graphical, audio, textual, and/or other information. Additionally, served ads may be sent in response to ad requests. A served ad may be selected based on ad-screening rules and/or conflict resolution between advertisers competing to provide the selected ad.

### RELATED APPLICATIONS

The present application claims priority to U.S. Provisional Patent Application No. 61/075,093, filed on Jun. 24, 2008, entitled “A Branded Advertising Based Dynamic Experience Generator”, the entire contents of which are hereby incorporated by reference herein.

### FIELD OF THE INVENTION

This invention generally relates to information processing, and particularly relates to providing branded advertising experiences using dynamic-community information, service features, service activity, country of origin, and/or device-related information.

### BACKGROUND

As networked computers have become more widespread, people and organizations (e.g., businesses, non-profit organizations, and government offices) have found social uses for computers. Many social uses are associated with social-networking websites as well as many on-the-job activities. These social uses now include sharing of most, if not all, types of information that can be shared out electronically. Example social-networking websites include Yahoo!, Facebook, Twitter, MySpace, and YouTube.

Each of the social-networking websites permits individuals and/or organizations to register as users of the social-networking website. Once registered, the user may be permitted to enjoy use of various services, such as e-mail, blogging, picture and video sharing, and sending of short messages. Many social-networking websites have one or more specialties that attract visitors to the website; for example, YouTube specializes in video sharing.

Additionally, many people have access to computers at work. Frequently, business activities, such as meetings, conference calls, workshops, and lectures, involve both social and electronic-communication aspects as well. One common example is an electronic meeting notice e-mailed or otherwise electronically disseminated to all persons invited to a meeting or conference call.

Websites accessible via the Internet and other public networks often have some form of advertising. Common techniques for advertising related to a requested web page are typically follow “ad view and discard” models, such as “banner ads” or advertisements embedded into the requested web page and “pop-up ads” or advertisements displayed in a separate window of a web browser that is also displaying the requested web page.

Ad view and discard techniques are frequently ignored by users. Additionally, pop-up ads typically are blocked by user browser settings. Therefore, advertisers may seek alternatives to provide a computerized branding experience that better engages the eyes, ears, and/or minds of a target audience for their products and services. Ideally, total user attention should be focused on the ad, which is difficult to do when served with content.

### SUMMARY

A first aspect of the invention is a method. The method is to be performed by a computing device. A trigger is received. The trigger includes ad-related data. An ad request is sent to an ad server based on the trigger. A served ad is received based in response to the ad request. A response to the trigger is sent. The response to the trigger includes the served ad.

A second aspect of the invention is an apparatus. The apparatus includes a processing unit, a network-communication interface, data storage, and machine-language instructions stored in the data storage. The machine-language instructions are executable by the processing unit to perform functions. The functions include: (a) receiving an ad request associated with a trigger via the network-communication interface, where the ad request includes ad-related data, (b) determining a served ad based on the ad-related data, and (c) sending the served ad via the network-communication interface.

A third aspect of the invention is a method. The method is to be performed by a computing device. A trigger is intercepted. The trigger includes dynamic-community information. The trigger is sent to a server. A response to the trigger is received from the server. An ad request and an ad server are determined based on the trigger. The ad request is sent to the ad server. In response to the ad request, a served ad is received. A response to the trigger is sent. The response to the trigger includes the served ad.

### BRIEF DESCRIPTION OF THE DRAWINGS

Various examples of embodiments are described herein with reference to the following drawings, wherein like numerals denote like entities, in which:

FIG. 1 is an example communications network, in accordance with embodiments of the invention;

FIG. 2 is a block diagram of an example MTproxy, in accordance with embodiments of the invention;

FIG. 3A depicts a scenario of authenticating an MTclient, in accordance with embodiments of the invention;

FIG. 3B depicts a scenario for using piggybacking operations to deliver served ads, in accordance with embodiments of the invention;

FIG. 4 depicts a scenario for using push operations to deliver served ads, in accordance with embodiments of the invention;

FIG. 5 depicts an example computing device, in accordance with embodiments of the invention;

FIG. 6 is a flowchart depicting an example method, in accordance with embodiments of the invention; and

FIG. 7 is a flowchart depicting an example method, in accordance with embodiments of the invention.

### DETAILED DESCRIPTION

This invention is related to techniques and apparatus suited to better provide a branding experience for a product by focusing the eyes, ears, and minds of a target audience on “served ads” in accordance with a dynamic community associated with the target audience. This invention allows user interaction with the brand on a continuous basis using criteria described in detail below. The criteria may be determined by an advertiser and/or the owner of a network, such as the herein-described MT Network, instead of a mere ad view and discard model (e.g., banner or pop-up ads). Each served ad may include graphical data, audio data, textual data, and/or other data that enable automatic presentation of timely information (e.g., service bulletins, new product release dates, coupons) from advertisers and others who wish to reach the target audience.

As the use of social-networking websites expands, social and other information related to events, topics, and/or people is divided among social-networking websites. This invention is related to the formation and use of “dynamic communities” to aggregate information divided among various websites and data repositories. Dynamic communities may be long term or short term in nature; for example, a relationship with a medical provider is likely to be short term, but a collection of people attending a sporting event is likely to be short term. Advertisers may be interested in both types of communities. For example, a pharmaceutical or medical equipment manufacturer may be interested in the long-term medically-related dynamic community described above, and a sporting team or nearby restaurant owner may be interested in the sporting-related

Dynamic communities may be formed at one or more servers, each server herein named an “MTserver”, based on a “trigger”. The trigger may be a command, a request for information or an “event indication” related to an external activity. Example event indications include an indication a person has changed location (e.g., a notification that Elvis has left the building), occurrence of a news event (e.g., a tornado has touched down near Plainfield, Illinois), receipt of an e-mail message, posting of a blog entry, or a specific social-networking activity (e.g., a picture has been posted/retrieved, a comment has been logged).

Dynamic communities may also be related to “operations” applied to one or more “data sources”. Example operations include sending a message, searching for requested information, or retrieving contact information. In some contexts, the triggers may be divided into “pull” operations that bring data to a user upon request of the user (that is, the user “pulled” the data in by request) and “push” operations that bring data to the user without a request (that is; the data is “pushed” onto the user). Example data sources include social-networking websites, other websites, work-related websites, and other data repositories. Data may be “piggybacked” or added to messages related to either push or pull operations.

For example, suppose Jane Doe, a resident of Los Angeles, wants to invite all of her friends currently in town to a party. Jane may send a command to an MTserver to send the party invitation to all of her contacts stored at several social-networking websites in Los Angeles. The MTserver may then form a dynamic community of all Jane's contacts, filter the contacts based on Jane's location criteria, and then send the party invitation to the filtered set of contacts. The filtering of location criteria would be determined based on the results of previous events indicating the locations of each of Jane's contacts. Further, Jane may send a command to the MTserver to inform her of electronic messages (e.g., e-mail, SMS, electronic invitation responses, etc.) received from these contacts. The MTserver may handle each received message as an event, create a dynamic community for Jane (and perhaps the sender of the received message), and then send a notification of the event to the dynamic community. A served ad or other data may be piggybacked on to messages conveying the sent party invitations and/or the notification of the event.

The MTserver may be in communication with an “MTproxy”. The MTproxy, which may be a separate computing device from the MTserver and/or a software component of the MTserver, acts on a user's behalf to process triggers. The MTproxy may receive triggers from either an “MTclient” or user application (e.g. for pull operations) or from the MTserver (e.g., for push operations). Upon reception of the trigger, the MTproxy may perform and/or coordinate the performance of any necessary computational operations needed to service the trigger; e.g., start and/or stop processes or threads, instantiate or deallocate objects and/or other data structures, send messages to and receive messages from the MTserver, and/or request or send messages to external devices such as websites or servers. Many other computational operations may be used to service the trigger as well.

As part of servicing the trigger, the MTproxy may enable immersion into a “branding experience”. Immersion into the branding experience may include delivering a served ad along with any information needed to service the trigger. The MTproxy may provide the information needed to service the trigger and the served ad to an MTclient. Once the MTclient receives the served ad, the MTclient may change a display and/or play tones in accordance with the served ad to immerse a user of the MTclient in the branding experience.

One or more served ads may be provided to any number of MTclients based on information in the dynamic community, such as but not limited to phone numbers, “device-related information” (e.g., information about a device such as a mobile phone, including but not limited to manufacturer, model information, hardware and/or software version information, addressing information, etc.), telephone and/or social-networking service features used, location, social-networking-website, and/or dynamic community membership. One or more served ads can be sent to one or more MTclients at a time. The MTclient(s) that receive served ad(s) may be filtered based on certain criteria; e.g., selecting devices only in a specified geographic region. The entire population of MTclients may have one or more served ads active at any time.

The served ad may include graphical data, audio data, textual data, and/or other data. The graphical data may include graphical information regarding user interface (UI) icons, background images, foreground images, video images, streaming video, “splash screens” coupons, and/or other served ad-related graphical objects. The audio data may include alert sounds, partial or complete songs (e.g., ring tones), speech, streaming audio, and/or other served ad-related audio objects. Textual data may include formatted text, unformatted text, and/or other served ad-related textual objects. Other information may include, but is not limited to, other information not previously described, perhaps in a binary and/or other machine-readable format (e.g., access keys, software, compressed data, encrypted data, etc.)

This graphical, audio, textual, and/or other information may include direct and/or referential objects. A direct object may be a copy of the data immediately displayable or playable by a device. A referential object may be a data object that is not a copy of the data, such as a “pointer” or other reference to an object already stored and accessible by a device. Using the example of an graphical information regarding an icon, a direct graphical object may be a Graphics Interchange Format (GIF), Joint Photographic Expert Groups (JPEG), or other graphics file displayable as an icon, while a referential graphical object may be a reference to the icon; e.g., “Disby_co icon” or icons.mobiletribe.com/icon_{—}4. Similarly, a direct audio object may data playable as music or other sounds upon reception at a device; e.g., a ringtone file, while a referential audio object may include a reference regarding sounds; e.g., “disby_skin.audio.PingTone” or audio.mobiletribe.com/splash_song1. Direct and referential textual and other objects also may be defined and used.

The objects of a served ad may be coordinated to create the branding experience. For example, to create the “Mobile Tribe Experience” for the Mobile Tribe Company, many or all UI icons, splash screens, and background image, may used Mobile Tribe related imagery, such as a Mobile Tribe logo, images of people related to Mobile Tribe, cartoons or other graphics related to Mobile Tribe, objects (e.g., products) related to Mobile Tribe and/or other pictures related to Mobile Tribe. In this example, to create and/or enhance the Mobile Tribe branding experience, ring tones, UI tones, start-up and/or shut-down music may consist of Mobile Tribe related audio, and/or textual information, advertising messages, coupons, URLs, and other text related to Mobile Tribe may be provided as well.

In some embodiments, advertisements using graphical, audio, textual, and/or other information (including objects) may be provided by an MTproxy that are unrelated to a served ad. For example, a coupon or other information from an advertiser unrelated to a served ad or the branding experience may be provided to an MTclient.

Different advertisers may choose more or fewer objects to provide the branding experience. For example, a first advertiser may use of graphical data alone to create a first branding experience, while a second advertiser may use of graphical, textual, audio, and other data to create a second branding experience. Pricing models for delivery of branding experiences may take the amount and type of information in a branding experience into account; e.g., the first advertiser in the example above may be charged less per branding experience provided to an end user than the second advertiser.

The served ad may be selected based on information in a dynamic community or “dynamic-community information” related to the trigger and/or one or more “ad-screening rules”. In particular, the dynamic-community information includes user(s) associated with MTclient(s) receiving information regarding the trigger. “Ad-related data” for the user may be gathered from and/or otherwise based on the dynamic-community information; e.g., ad-related data may be stored in the data sources of the dynamic community. The ad-related data may include information important to advertisers, such as but not limited to, information related to user demographics and preferences. The ad-related data may be stored, perhaps in a database, on the MTproxy, MTserver, on an “internal ad server”, and/or on dedicated server(s) (e.g., “MTdata” server(s)).

One aspect of gathering ad-related data involves searching the data sources of the dynamic community. For example, a user whose data sources include automobile-related social-networking sites likely has an interest in automobiles. As another example, a dynamic community may include a social-networking website as a data source. The social-networking website may maintain a profile for the user with demographic and/or preference information. This profile may be part of the ad-related data for the user. Data stored on dynamic-community-related data sources may provide additional ad-related data; for example, a blog entry or website posting may indicate user preferences; e.g., a blog entry favoring a particular restaurant.

The internal ad server may use ad-screening rules to determine which of several possible served ads to provide to the MTproxy and then to the MTclient. The ad-screening rules may be subject to conflict resolution, such as rules that prevent multiple advertisers of the same advertising category to provide served ads at the same time and/or limit a number of delivered served ads based on contractual agreements among multiple advertisers. An advertising category may be a type of product and/or service provided; e.g., Acme Brand Anvils may be included in an “anvils” advertising category.

For example, suppose the MT Network provides served ads to MTclients for two competing beverage manufacturers: DrinkMoreOften and Yummy-o-rama Soda Pop. If contractual or other business relationships so dictate, conflict resolution rules may ensure competing served ads (i.e., served ads from advertisers in the same advertising category), such as Yummy-o-rama Soda Pop ads, are not served while visiting a DrinkMoreOften-related website. However, conflict resolution rules may or may not prevent a served ad other than competing ads (e.g., an Acme Brand Anvils or Fox's Henhouse Guarding Services served ad) from being served while visiting a DrinkMoreOften-related website.

Continuing this example, suppose the MT Network has contractual arrangements to deliver 1,000 served ads/day for both DrinkMoreOften and Yummy-o-rama Soda Pop. Further suppose that, halfway thorough a given day, 550 DrinkMoreOften served ads had been delivered and 200 Yummy-o-rama ads had been served. For both DrinkMoreOften and Yummy-o-rama Soda Pop, assume that 500 served ads are expected to be served halfway through the given day. Then, conflict resolution rules may increase the priority of Yummy-o-rama ads and/or decrease the priority of DrinkMoreOften ads until the number of Yummy-o-Rama ads is roughly or exactly the expected number ads to be delivered based on the time of day.

The herein-described techniques and apparatus permit effective generation of a branding experience by coordinating application and device activity such as the splash screen, messages and icons to provide an advertiser-requested look and feel. The branding experience may include targeted advertising based on user context as well as user identification such as phone numbers, device-related information, user location (geo-location), country of origin, service features used, social interactions, community membership etc. The branding experience helps create a dialog between advertisers and users of the MT Network that have been identified to have an affinity for the advertiser and/or the advertiser's products and/or services.

An Example Communication Network

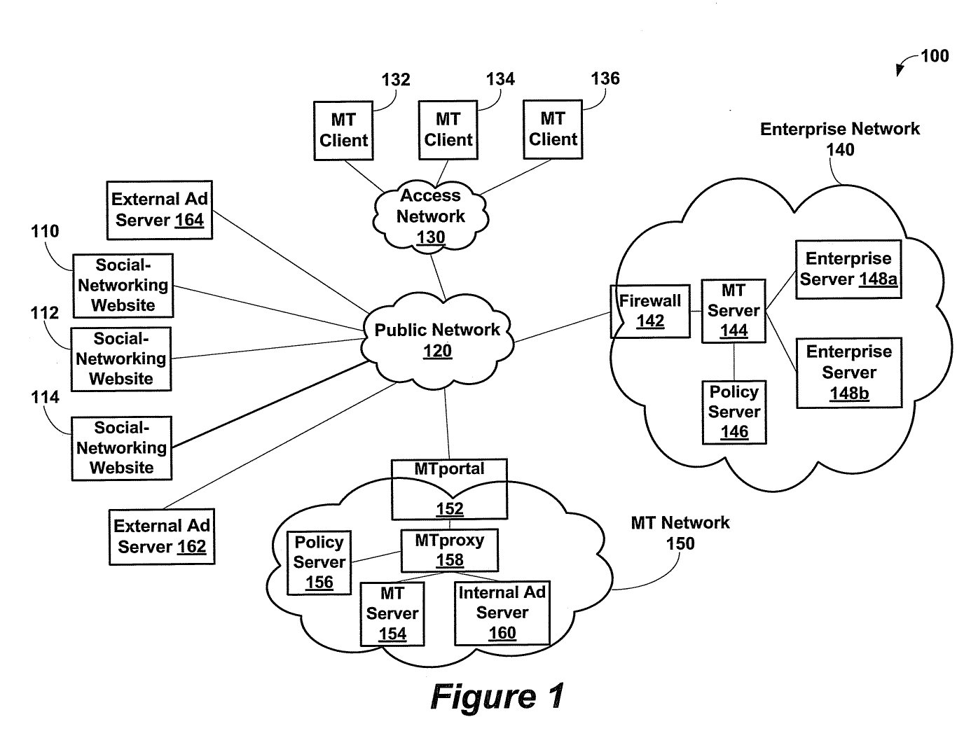

Turning to the figures, FIG. 1 is an example communications network 100, in accordance with embodiments of the invention. It should be understood that this and other arrangements described herein are set forth only as examples. Those skilled in the art will appreciate that other arrangements and elements (e.g., machines, interfaces, functions, orders, and groupings of functions, etc.) can be used instead, and that some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. Various functions may be carried out by a processor executing machine-language instructions stored in memory or data storage.

As shown in FIG. 1, the example communication network 100 may include one or more social-networking websites 110, 112, and 114 each connected to a public network 120, an access network 130 connecting one or more MTclients 132, 134, and 136 to the public network 120, an enterprise network 140 connected to the public network 120, and an MT network 150 connected to the public network 120, and one or more external ad servers 162 and 164, each connected to the public network. Additional network entities not depicted in FIG. 1 could be present as well. As examples, there may be more or fewer MTclients in communication with the public network 120, social-networking websites, external ad servers, access networks, and/or enterprise networks in communication with public network 120. Further, there may be other data repositories, servers and websites not shown in FIG. 1 in communication with the public network 120, access network 130, enterprise network 140, and/or MT Network 150. Additionally, public network 120, access network 130, enterprise network 140, and/or MT Network 150 may include more or fewer entities than shown in FIG. 1.

There could be one or more devices and/or networks making up at least part of one or more of the communication links depicted in FIG. 1. As an example, there could be one or more routers, switches, or other devices or networks on the link between the public network 120 and the MTportal 152. Additionally, the herein-described functionalities of the public network 120, access network 130, enterprise network 140, and/or MT Network 150 may be combined into one network.

To carry out these functions, each of the social-networking websites 110-114, MTclients 132-136, firewall 142, MTservers 144 and 154, policy servers 146 and 156, enterprise servers 148a and 148b, MTportal 152, MTproxy 158, internal ad server 160, and/or external ad servers 162 and 164 may take the form of a computing/communication device, such as a cell phone, personal digital assistant, wirelessly equipped personal computer, personal computer, application server, computing unit, or other entity now known or later developed configurable to carry out the herein-described functionality of a social-networking website, MTclient, firewall, MTserver, policy server, enterprise server, MTportal, MTproxy, internal ad server, and/or external ad server.

Public network 120 may be the Internet or may comprise some other public or private packet-switched and/or circuit-switched network. Public network 120 could include any number of gateways, routers, proxies, and other intervening elements and may include one or more of the elements of the access network, enterprise network 140, and/or MT Network 150 described herein.

Each MTclient 132, 134, and 136 may likewise take various forms, examples of which include the computing/communication devices listed above, and may each be configured to perform the herein-described functionality of an MTclient. The social-networking websites 110-114, MTclients 132-136, firewall 142, MTservers 144 and 154, policy servers 146 and 156, enterprise servers 148a and 148b, MTportal 152, MTproxy 158, internal ad server 160, and/or external ad servers 162 and 164 may be further programmed with a plurality of applications, each of which serves a discrete device function that may or may not involve user interaction. Examples of such applications include, without limitation, voice processing, image processing, word processing, phone book, calendar, spreadsheet, games, audio player, video player, web browser, image management, graphics editing, utilities, web-logs (“blogs”), online encyclopedias (“Wikis”), directory services, and other applications now known or later developed. In some embodiments, some or all of MTclients 132, 134, and 136 may have a wireless-communication interface comprising an antenna and a chipset for communicating with one or more access nodes over an air interface, such as but not limited to a GSM, UMTS, 3G, CDMA, TDMA, WiFi, WiMAX, and/or EV-DO air interface(s).

Each of the social-networking websites 110-114 may provide access to application data, such as contact lists, messages, video content, textual content, audio content, binary data, and/or other information. The access may be permitted to users that have subscribed to a given social-networking website 110- 114. For example, social-networking website 110 may provide users to subscribe and then permit subscribed users to send and receive e-mail, news, and other information.

FIG. 1 shows the enterprise network 140 with firewall 142, MTserver 144, policy server 144, and enterprise servers 148a and 148b. The firewall 142 may be connected to the public network 120 and protect enterprise network 140 from unauthorized access and electronic attacks/viruses entering via the public network 120. The firewall 142 may also restrict access from within the enterprise network 140 to the public network 120; for example, the firewall 142 may not allow access to certain websites from devices within the enterprise network 140. The MTserver 144 may be connected to the firewall 142, policy server 146 and the enterprise servers 148a and 148b. The MTserver 144 and policy server 146 may perform the functions of the herein-described MTserver and policy server, respectively. Enterprise servers 148a and 148b may permit employees or other persons associated with the enterprise with e-mail to use the applications described above.

The MT Network 150 may include an MTportal 152 connect to the public network 120, an MTproxy 158 connected to the MTportal 152, the MTserver 154, policy server 156, and an internal ad server 160. The MT Network 150 may be a physical network or may be an overlay network.

Note that the herein-described functionality of the MTportal, MTproxy, MTserver, policy server, and/or internal ad server may be combined and performed on one physical device. In some embodiments, multiple physical devices may be used to perform the herein-described functionality of the MTportal, MTproxy, MTserver, policy server and/or internal ad server.

The MTportal 152 may provide access to the MTclients 132-136 to the MT Network 150. The MTproxy 158 may receive requests from the MTclients 132-136 and act on their behalf within the MT Network 150 to service the requests. Additionally, the MTproxy 158 may act on behalf of the MTclients 132-136 for handling events and event indications within the MT Network 150. In some embodiments, the MTproxy 158 may comprise the functionality of a herein-described ad interceptor. Additionally or instead, the MTproxy 158 may perform the functions of the herein-described MTproxy. The MTserver 154, policy server 156, and internal ad server 160 may perform the functions of the herein-described MTserver, policy server, and internal ad server respectively.

The external ad servers 162 and 164 may provide advertisements and other information upon request or otherwise. In particular, the external ad servers 162 and 164 may each be configured to provide advertisements and other information as requested by one or more entities within the MT Network 150, such as but not limited to the MTportal 152, MTserver 154, policy server 156, MTproxy 158, and/or internal ad server 160. The external ad servers 162 and 164 each may perform the functions of a herein-described external ad server.

An Example MTproxy

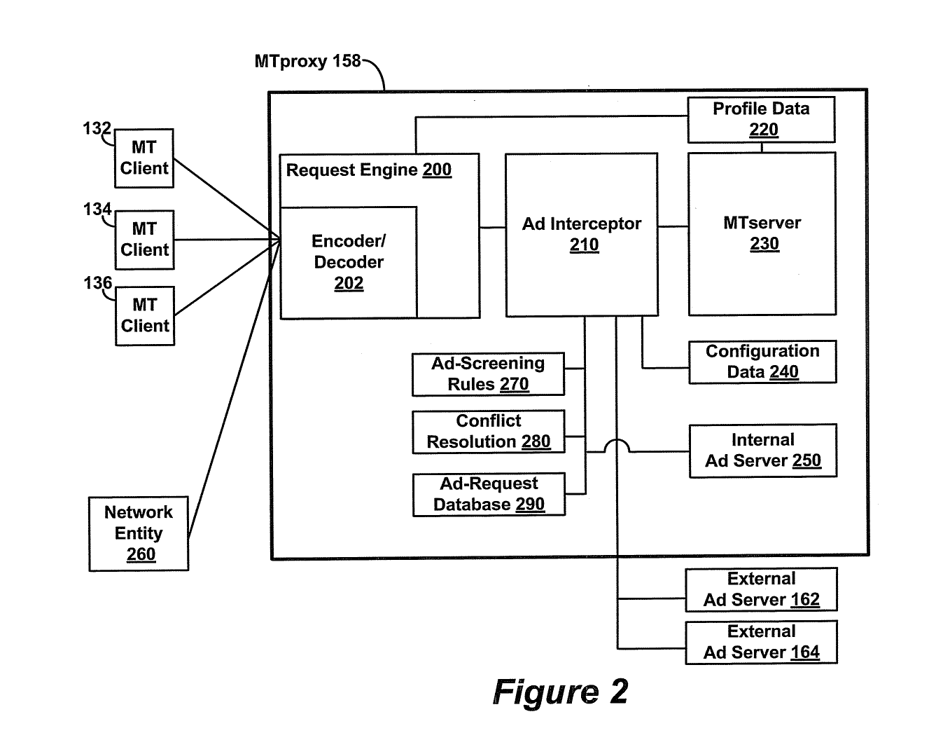

FIG. 2 is a block diagram of an example MTproxy 158, in accordance with embodiments of the invention. The MTproxy 158 may be configured to service requests and to provide notifications on behalf of MTclient(s) 132, 134, 136 within the MT Network 150.

As shown in FIG. 2, the MTproxy 158 may include a request engine 200, an ad interceptor 210, profile data 220, an MTserver 230, configuration data 240, an internal ad server 250, ad-screening rules 270, conflict resolution 280, and ad-request database 290. The MTproxy 158 may be configured to communicate with one or more MTclients 132, 134, and 136, perhaps via an access network (as shown in FIG. 1, but not shown in FIG. 2), one or more external ad servers 162 and 164, and/or one or more network entities 260.

Network entity 260 may be one or more devices configured as either part of communication network 100 shown in FIG. 1 and/or configure to communicate with any or all of the entities in communication network 100. As such, network entity 260 and MTproxy 158 may exchange one or more messages, such as event notifications, e-mail, Short Message Service (SMS) messages and/or other types of messages with video data, textual data, audio data, binary data and/or other types of data in each message.

The functionality of the request engine 200, ad interceptor 210, MTserver 230, configuration data 240, internal ad server 250, ad-screening rules 270, conflict resolution 280, and/or ad-request database 290 could be located on any devices of the MT Network 150 (e.g., MTportal 152, MTserver 154, policy server 156, MTproxy 158, and/or internal ad server 160). The request engine 200, ad interceptor 210, MTserver 230, configuration data 240, internal ad server 250, ad-screening rules 270, conflict resolution 280, and/or ad-request database 290 could be hosted on several separate servers, such as shown in the example arrangement of MT Network 150 of FIG. 1, or on one server as shown in FIG. 2.

The request engine 200 is configured to exchange messages with clients, such as MTclients 132, 134, and 136 as shown in FIG. 2. In particular, the request engine 200 may receive requests or other messages from MTclients 132, 134, and 136, external ad server 162, 164, and/or network entity 260. The requests and other messages may be decoded by encoder/decoder 202, and then passed on to the MTserver 230 via ad interceptor 210. Similarly, messages from the network entity 260 may be received at the encoder/decoder 202 and passed on to the MTserver 230.

Responses or other messages to be sent from the MTserver 230 may tale the reverse path to the encoder/decoder 202 via ad interceptor 210. Once at the encoder/decoder 202, a response may be encoded and sent to one or more destinations, such as but not limited to MTclients 132, 134, 136, external ad server 162, 164 and/or network entity 260. In some embodiments, the ad interceptor 210 may receive requests or other messages and send responses or other messages as well.

The ad interceptor 210 may process advertising-specific commands and/or intercept messages (e.g., responses, event notifications) destined for MTclient 132, 134, and 136. After intercepting or otherwise receiving a message destined for one or more MTclients, the ad interceptor 210 may be configured to piggyback a served ad onto the intercepted/received message.

The ad interceptor 210 may be configured to simultaneously communicate with multiple internal and/or external ad servers. In particular, the ad interceptor 210 may determine which internal ad server 250 and/or external ad server 162, 164 is associated with a given served ad based on configuration data 240, internal ad server 250, ad-screening rules 270, and/or conflict resolution 280. The configuration data 240 may include one or more ad-server addresses, such as an address of the internal ad server 250 and/or an address of an external ad server 162, 164, as well as other herein-described configuration data.

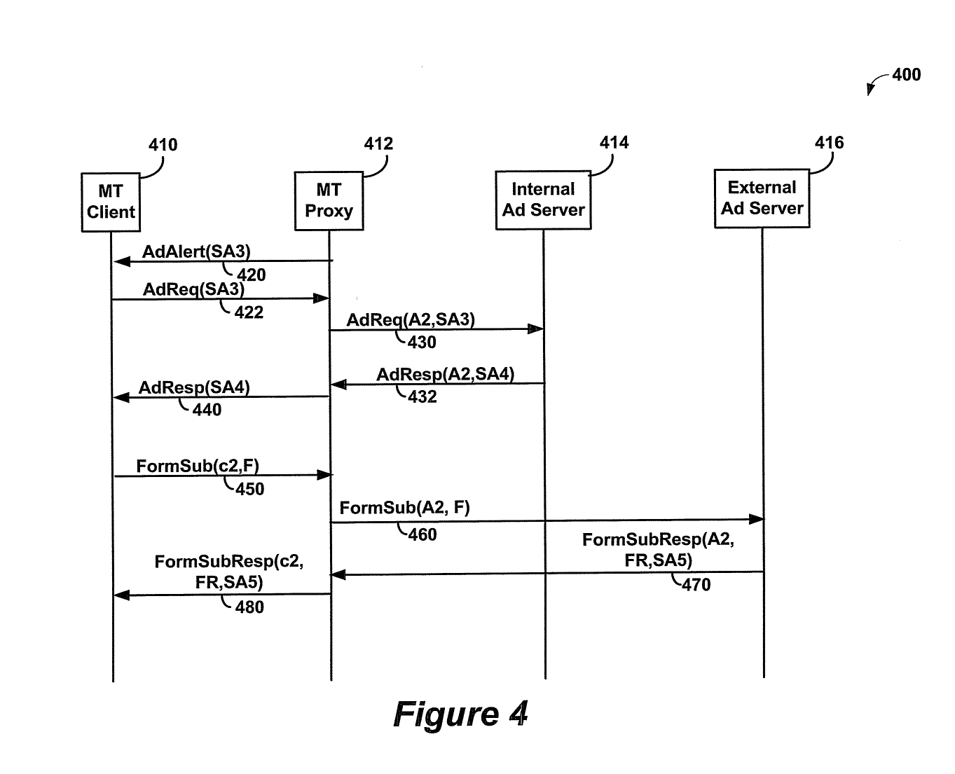

The ad interceptor 210 may process the actions in “ad-submit” or “form submit” advertising-related commands received from MTclients 132, 134, and 136. Both internal ad server 250 and external ad servers 162, 164 may be configured to perform actions specific to the ad-submit command; e.g., provide a specific served ad or compose a served ad by selecting graphical, audio, textual, and/or other information. The ad interceptor 210 may update an ad-request database 290 with data about served ads provided to MTclients 132, 134, and 136. In response to an ad request or a form-submit command, the MTproxy 158 may return information and/or served ad(s) to the MTclients 132, 134, and 136, as described below in more detail with respect to FIG. 4.

The ad interceptor 210 may receive the dynamic-community information, including profile data 220 and/or other dynamic-community information, from MTserver 230 related to a specific user of MTclient 132, 134, and 136. The ad interceptor 210 may determine ad-related data based on the dynamic-community information, perhaps associated with a given request or message to/from an MTclient 132, 134, 136 and/or network entity 260, as described above.

The ad-related data may provided by the user or other entity associated with MTclient 132, 134, 136 and/or network entity 260 on a variety of social networking websites. The ad-related data may be correlated by checking and/or cross-checking available data between a number of data sources in a dynamic community (e.g., social-networking websites, work-related computers, other computers and data repositories). This correlation may both confirm the accuracy and increase the amount of the ad-related data. In some embodiments, a user may be prompted to verify ad-related data; e.g., the user may receive a message indicating “Please tell us about your interest in Acme Brand Anvils”.

The ad-related data may be stored, such as in the ad-request database 290, and/or may be sent to an advertiser or other advertising-related entity (e.g., marketing data service, advertising agency) to share, verify, and/or enhance the data. The advertiser or other advertising-related entity may in turn provide the ad interceptor 210 with updated ad-related data for the user, perhaps by verifying the ad-related data, adding ad-related data from other sources (e.g., off-line sources), and/or removing data not used by the advertiser. The ad interceptor 210 may provide ad-related data to the internal ad server 250 and external ad servers 162, 164. The ad interceptor 210 may provide the ad-related data as part of the ad request, such as in a URL, as a cookie, or in some other format.

The ad interceptor 210 and/or internal ad server 250 may initially determine one or more served ads based on the ad-related data. Then, ad-screening rules 270 and/or conflict resolution 280 may be applied to the initially-determined served ad(s). Based on the application of ad-screening rules 270 and/or conflict resolution 280, one or more actually-served ad(s) may differ from the initially-determined served ad(s). In some embodiments, the ad-screening rules 270 may be applied and/or conflict resolution 280 may be performed before selecting any served ad as an actually-served ad, thereby eliminating the need to determine any initially-determined served ad(s).

The ad-screening rules 270 may indicate which of several advertisers whose ad(s) are to be selected as the actually-served ad(s). The ad-screening rules 270 may include rules to select an advertiser based on demographic information, user preferences, time of day, advertiser category, number of served ads provided by the MT Network, and/or contractual/business-related rules. For example, an advertiser in the hair-coloring advertiser category may be selected for a person whose dynamic community has provided information that (a) the person is 67 years old and/or (b) is a member of the “SuddenlySingleSeniors” website.

The ad-screening rules 270 may be subject to conflict resolution 280, such as rules that prevent multiple advertisers of the same advertising category to provide served ads at the same time and/or limit a number of delivered served ads based on contractual agreements among multiple advertisers. Conflict resolution 280 may involve completely or partially prioritizing delivery of served ads for a specific advertiser, based on conflict resolution factors such as, but not limited to, time, location, advertiser category, contractual arrangements, and/or other business arrangements. Conflict resolution 280 may be based on rules that are part of the ad-screening rules 270 or may be performed using separate data and/or as a separate process. Many other techniques for ad-screening rules 270 and/or conflict resolution 280 are possible as well.

Contemporaneously with providing the actually-served ad to a destination (e.g., MTclient 132, 134, 136 and/or network entity 260), the ad-request database 290 may log/store information related to the actually-served ad, such as, but not limited to, actually-served ad identification information, data related to advertiser(s) and/or other advertising-related entity/entities associated with the actually-served ad, data about the destination of the actually-served ad, timing information, and other information.

An Example Authentication Scenario

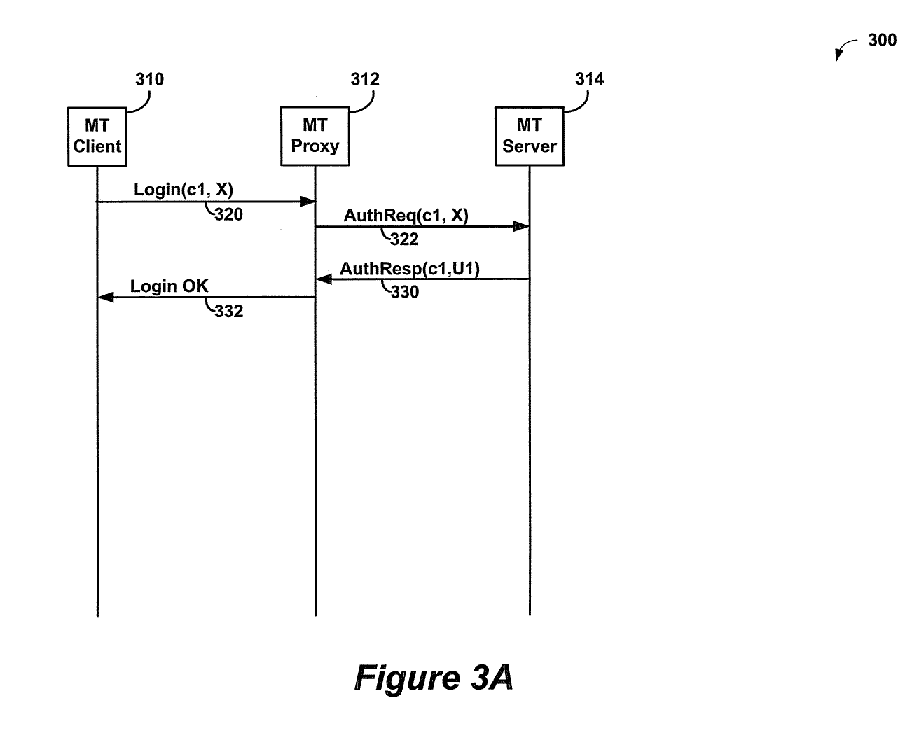

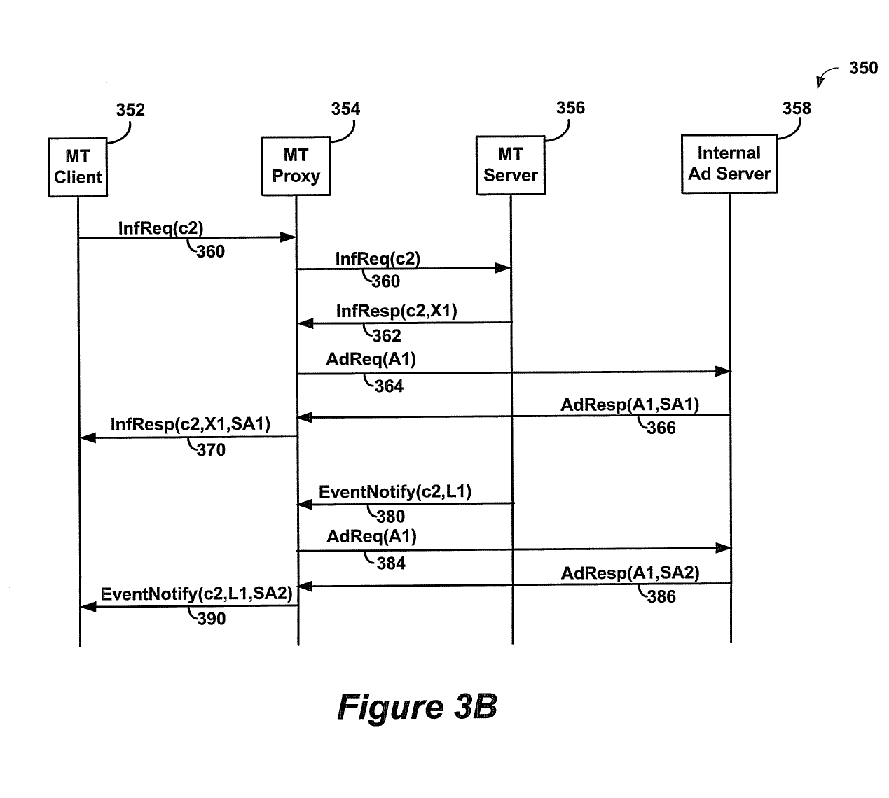

FIG. 3A depicts a scenario 300 of authenticating an MTclient 310, in accordance with embodiments of the invention. Messages, requests, responses, events, event indications, and/or calls shown in scenarios 300, 350, and 400 as depicted in FIGS. 3A, 3B, and 4, respectively, may pass through one or more networks during their transmission. The one or more networks include, but are not limited to, access networks, public data networks, private data networks, wired networks, wireless networks, local area networks (LANs), and wide area networks (WANs).

The MTclient 310 may send a Login message 320 to MTproxy 312. FIG. 3A shows the Login message 320 includes an indication of a contact (or user) name “cl” and authentication information “X”. The authentication information may be a password, authentication key, application key, or other similar data now known or to be discovered that acts to authenticate a contact. In some embodiments, the Login message 320 may not include the contact name c1 and/or the authentication information X.

At the MTproxy 312, an authentication request (“AuthReq”) 322 may be generated based on Login message 320. The AuthReq 322 may include with the contact name c1 and authentication information X. FIG. 3A shows MTproxy 312 sending AuthReq 322 to MTserver 314. In some embodiments, MTserver 314 may determine that AuthReq 322 is to be processed by an Authentication, Authorization, and Accounting server (“AAA”) (not shown in FIG. 3A) to verify the authentication information X for contact c1.

The MTserver 314 may determine that user profile information “U1” is associated with the contact name c1. The user profile information U1 may include ad-related data. Ad-related data may include, but is not limited to, contact information for c1 (e.g., name or other identification information, phone numbers, paper-mail addressing information, e-mail or other electronic addressing information,), demographic information (date of birth/age information, gender, family background information, profession/job information), financial information (e.g., bank account information, credit card number/expiration date, income information), device-related information, user-preference information (e.g., user-selectable information related to an advertiser such as a preference for Acme Brand Anvils), service usage/activity information (e.g., e-mail usage information, types of services used, time(s) and date(s) of service usage/activity, total daily/monthly/annual service usage/activity time, etc.) and/or social-networking information (e.g., addressing information about social-networking websites/other data sources, subscription information, and/or other information about social-networking websites and/or other data sources, information based on one or more messages, such as blog entries, newsgroup postings and/or social networking website postings).

In some cases, ad-related data may not be associated with user profile information. Many other types of user profile information and/or ad-related data may be included as well.

Based on the user profile information U1 (and any subsequent verification), the MTserver 314 may generate an authentication response (“AuthResp”) 330. In this scenario, a successful authentication is assumed; however, other scenarios are possible where the authentication response is unsuccessful. The AuthResp 330 provides an indication of the authenticated contact name cl and the user profile information U1. In other scenarios, the user profile information U1 may be null if no user profile information is to be provided or is otherwise unavailable.

FIG. 3A shows that the MTserver 314 sends the AuthResp 330 to MTproxy 312, as MTproxy 312 is associated with the contact having contact name c1. The MTproxy 312 may store (e.g., cache) the user profile information U1 and associate the user profile information U1 with the contact name c1, perhaps for use as ad-related data regarding a contact with contact name c1.

Upon reception of the AuthResp 330, MTproxy 312 may reformat the AuthResp 330 or otherwise generate a “Login OK” message 332. Once the Login OK message 332 has been generated by the MTproxy 332, FIG. 3A shows the Login OK message 332 sent from the MTproxy 312 to the MTclient 310.

In some embodiments, the Login message 320 and AuthReq 322 are formatted in the same way; therefore, the Login message 320 and the AuthReq 322 may be identical. Similarly, in some embodiments, the AuthResp 330 and the Login OK message 332 may be identical.

Upon receiving the Login OK message 332, the MTclient 310 may be deemed as authorized to access functionality associated with the MT Network 150. In scenarios described with respect to FIGS. 3B and 4, any required authentication/authorization is assumed to have been performed prior to a given scenario.

An Example Piggybacking Operation Scenario

FIG. 3B depicts a scenario 350 for use of piggybacking operations to deliver served ads, in accordance with embodiments of the invention. Scenario 350 shows examples of piggybacking served ads onto requests for information and event notifications. The ability to piggyback ads onto traffic flows initiated by asynchronous user requests improves the scale of the MT Network and reduces network traffic. Additionally, served ads delivered with requests for information are guaranteed to find an active end user for viewing and potential action.

As shown in FIG. 3B, MTclient 352 formats an information request (“InfReq”) 360 and sends it to MTproxy 354. In scenario 350, InfReq 360 is an example request for information to find contact (or other) information related to a contact c2, perhaps by searching in one or more directories for an individual and documents and e-mail/SMS addresses related to the contact c2. Another example request for information may be a request for the closest restaurant to contact c2 that has been recommended by members of a club associated with a user of MTclient 352. Many other requests for information, such as but not limited to any herein-described request for information, are possible as well.

Note that contact c2 may indicate more than one contact. Further, the contact c2 may be indicated by various criteria, such as but not limited to name, address, phone number, e-mail address, and/or by reference to a contact list, address book, friends list, or similar data structure.

InfReq 360 may include a request for information involving multiple data sources available on the Internet and/or in enterprise networks. InfReq 360 may include criteria to identify the multiple data sources, such as, but not limited to, uniform resource locators (URL), uniform resource indicators (URIs), fully qualified domain names (FQDNs), Internet Protocol (IP) addresses, and/or other data-source-identification information. InfReq 360 may include criteria to identify the multiple data sources, such as, but not limited to, uniform resource locators (URL), uniform resource indicators (URIs), fully qualified domain names (FQDNs), Internet Protocol (IP) addresses, and/or other data-source-identification information.

InfReq 360 may be in the form of a URL, such as URLs described in more detail in U.S. patent application Ser. No. 12/485,688 (“the '688 Application”), entitled “Distributed Technique for Cascaded Data Aggregation in Parallel Fashion”, filed on Jun. 16, 2009, and incorporated herein by reference for all purposes.

FIG. 3B shows the MTproxy 354 performing two actions upon reception of InfReq 360. One action is that MTproxy passes on the InfReq 360 to MTserver 356 on behalf of MTclient 352. In response, the MTserver 356 may search dynamic-community information to gather the information requested in InfReq 360, such as described in more detail in the '688 Application. Once the information is gathered, MTserver 356 may generate an information response (“InfResp”) 362 that includes requested information “X1” for desired contact c2, and send InfResp 362 to the MTproxy 354 as shown in FIG. 3B.

A second action performed by MTproxy 354 upon reception of InfReq 360 is to determine if InfResp 362 is eligible to piggyback a served ad. The MTproxy may determine that InfResp 362 is eligible to piggyback a served ad by querying internal ad server 358. FIG. 3B shows the MTproxy sending an ad request (“AdReq”) 364 to internal ad server 358. The AdReq 364 may include ad-related data “A1”.

The ad-related data A1 may include any or all of the ad-related data described herein, including but not limited to user profile data obtained and/or cached as part of an authentication process, such as described above with respect to FIG. 3A. The ad-related data A1 may include other information as well, such as but not limited to, location information and/or information from event notifications related to MTclient 352 (e.g., event notifications including a location of MTclient 352 or messages sent/received by MTclient 352). Many other data may be included as ad-related data as well.

The ad-related data A1 may be stored to permit association between a specific MTclient (e.g., MTclient 152) and the ad-related data A1. This association may performed by storing ad-related data in a database or other data structure/application that permits querying for ad-related data based on information identifying a specific MTclient, such as but not limited to a user profile database storing ad-related data that may be searched by a unique user identifier associated with an MTclient and/or addressing information indicating a specific device utilizing an MTclient (e.g. an IP address). The ad-related data A1 may be retrieved from this database (or other data structure/application) based on the destination MTclient prior to sending AdReq 354.

In some embodiments, the MTproxy 354 may include an ad interceptor, such as ad interceptor 210, to generate AdReq 364 and to process any related responses such as ad response (“AdResp”) 366 shown in FIG. 3B. The AdReq 364 may include other data as well, such as a network related information and/or a transaction identifier or other identifying information to permit association between InfReq 360, AdReq 364, and any responses to these requests.

Upon reception of the AdReq 364, internal ad server 358 may determine a specific ad to be served. The served ad may be determined based on the ad-related data A1 in AdReq 364, as described above. Additionally or instead, the internal ad server 358 may query or otherwise use information from external ad servers (not shown in FIG. 3B), herein-described ad-screening rules, and/or herein-described conflict resolution to determine which ad is to become an actually-served ad.

In the scenario shown in FIG. 3B, internal ad server 358 determines that served ad “SA1” is ultimately to be served to MTclient 352 (i.e., SA1 is to be an actually-served ad). The internal ad server 358 may then generate an “AdResp” 366 response to AdReq 364. AdResp 366 may include ad-related data A1 and the served ad SA1. The ad-related data A1 and/or served ad SA1 may include identifying information to permit association between InfReq 360 and AdReq 364, such as the transaction identifier described above.

In some scenarios the internal ad server 358 may determine no ad is to be served—for example, MTclient 352 may have a subscriber relationship with the MT Network indicating that no ads are to be served to MTclient 352. If no ad will be served, the internal ad server 358 may reply to the AdReq 364 with a null served ad SA1 or may not reply at all to the AdReq 364. The MTproxy 352 may wait a pre-determined amount of time to receive a reply to AdReq 364 before determining that no reply is forthcoming to AdReq 364 (and thus, no ad is to be piggybacked with InReq 360).

Once MTproxy 354 has received InfResp 362 and AdResp 366, the MTproxy 354 may generate an information response (“InfResp”) message 370, which is a response to InfReq 360 with the requested information X1 about contact c2. FIG. 3B shows InfResp 370 sent from MTproxy 354 to MTclient 352 with served ad SA1 piggybacked. In some embodiments, served ad SA1 may be sent to MTclient 352 in a separate message before an information response is received by MTproxy 354. In this case, the served ad SA1 may be provided to MTclient 352 based on a timer programmed by MTproxy 354. Upon reception of served ad SA1, MTclient 352 may cache or otherwise store served ad SA1.

Contemporaneously with providing served ad SA1 to MTclient 352, the MTproxy 354 may log/store information related to served ad SA1, as SA1 has actually been served to MTclient 352. The information related to actually-served ad SA1 may include, but is not limited to: information regarding use/interaction of MTclient 352 with actually-served ad SA1, identification information about actually-served ad SA1, data related to advertiser(s) and/or other advertising-related entity/entities associated with actually-served ad SA1, data related to advertising categories related to advertiser(s) and/or other advertising-related entity/entities associated with actually-served ad SA1, data about the destination of the actually-served ad (e.g., MTclient 352), timing information such as a time when a message containing an actually-served ad was sent (e.g., InfResp 370 including SA1), size information about actually-served ad SA1, information about graphical, audio, textual and/or other information included in actually-served ad SA1, and other information related to actually-served ad SA1. The MTproxy 354 may store information related to actually-served ad SA1 in a database, such as ad-request database 290.

Served ads may be piggy backed onto event notifications, which are messages by an MTserver generated in response to various events (e.g., location changes, reception of a message at a social-networking website). Event notifications are described in more detail in the '688 Application.

In scenario 350, MTclient 352 has requested to be informed about the current location of contact c2. FIG. 3B shows an event notification “EventNotify” 380 regarding a current location L1 of a contact c2 being sent from MTserver 356 to MTproxy 354 in response to a change of location of contact c2. As MTclient 352 has requested this event notification, EventNotify 380 may include information indicating the destination MTclient (e.g., MTclient 352) to receive EventNotify 380.

Upon reception of EventNotify 380, MTproxy 354 may determine if EventNotify 380 is eligible to piggyback a served ad. MTproxy may determine that EventNotify 380 is eligible to piggyback a served ad using the same or similar procedures described above to determine that InfResp 362 is eligible to piggyback a served ad.

FIG. 3B shows the MTproxy sending AdReq 384 to internal ad server 358. The AdReq 368 may include ad-related data A1. The ad-related data A1 may be retrieved from a database (or other data structure/application) based on the destination MTclient prior to sending AdReq 384 as described above.

Upon reception of the AdReq 384, internal ad server 358 may determine which ad is to be served as a served ad as described in detail above. In the scenario shown in FIG. 3B, internal ad server 358 determines that served ad “SA2” is ultimately to be served to MTclient 352. The internal ad server 358 may then generate AdResp 386 with ad-related data A1 and the served ad SA1 as described in detail above.

Once MTproxy 354 has received EventNotify 380 and AdResp 384, the MTproxy may generate event notification EventNotify 390 to inform MTclient 152 about current location L1 of contact c2. FIG. 3B shows EventNotify 390 sent from MTproxy 354 to MTclient 352 with served ad SA2 piggybacked. In some embodiments, served ad SA2 may be sent to MTclient 352 in a separate message than EventNotify 390. In this case, the served ad SA1 may be provided to MTclient 352 based on a timer programmed by MTproxy 354.

Contemporaneously with providing served ad SA2 to MTclient 352, the MTproxy 354 may log/store information related to actually-served ad SA2, perhaps in an ad-request database, as described in detail above with respect to served ad SA1.

An Example Push Operation Scenario

FIG. 4 depicts a scenario 400 for using push operations to deliver served ads, in accordance with embodiments of the invention. Push operations involve operations where an MTclient explicitly requests served ads.

FIG. 4 shows MTclient 410 sending AdReq 422 to MTproxy 412. The AdReq 422 may be sent upon specific request by MTclient 410 or upon receiving an alert request (“AdAlert”) from MTproxy 412, such as AdAlert 420 shown in FIG. 4. The AdAlert 420 and/or AdReq 422 may reference a specific served ad, shown as SA3, for both AdAlert 420 and AdReq 422 in FIG. 4.

The MTproxy 412 may use one or more techniques to determine when to send alert requests and/or ad requests to one or more MTclients, such as MTclient 410. One technique is to periodically sending send alert requests and/or ad-submit commands. A related technique is to send alert requests and/or ad requests based on time-frame data stored as configuration data and/or other data by MTproxy 412. For example, the time-frame data may instruct the MTproxy to send an alert request (and/or an ad request) according to a time frame of once an hour between 4 PM and 8 PM on Mondays through Fridays, and to send an alert request (and/or an ad request) once every three hours at other times. Many other time frames are possible as well.

Alert requests and/or ad requests may be sent “contextually” based on a dynamic-community change. For example, an alert request (and/or ad request) may be sent each time an MTclient visits a new or different (social-networking) website, changes locations, and/or accesses pre-selected content. Contextual alert requests and/or ad requests may be generated based on the URL for a website (or other data source), based on keywords in the returned content, and/or upon other bases. Data related to contextual alert requests may be stored as configuration data and/or other data by MTproxy 412. Many other techniques are possible for sending send alert requests and/or ad requests as well.

Upon reception of AdReq 422 at the MTproxy 412, the MTproxy 412 may be configured to forward on AdReq 422 to an ad server. The MTproxy 412 may be configured with an ad interceptor to generate ad-related alert requests (e.g., AdAlert 420), process ad requests and/or form-submit commands (e.g., AdReq 422, FormSub 450), and any associated responses. The MTproxy 412 may include ad-related data “A2” as part of AdReq 430 before sending AdReq 430 to an ad server. The ad-related data A2 may be stored and associated with MTclient 410 as described above with respect to FIGS. 3A and 3B.

FIG. 4 shows that MTproxy 412 sends AdReq 430 with ad-related data A2 and stored ad SA3 to internal ad server 414. In other scenarios, AdReq 430 may be sent to external ad server 416. The internal ad server 414 may be selected as a destination for AdReq 430 based on an association with AdAlert 420 and/or served ad SA3. For example, the internal ad server 414 may have requested MTproxy 412 to send AdAlert 420 via either a request message (not shown in FIG. 4) and/or as part of configuration data or other data available to MTproxy 412. As another example, internal ad server 414 may have provided served ad SA3 to MTclient 410 via MTproxy 412.

FIG. 4 shows internal ad server 414 sending an AdResp 432 to MTproxy 412 in response to AdReq 430. The internal ad server 414 may determine a served ad SA4 to be provided to MTclient 410 based on ad-related data A2 and/or previously served ad SA3. The internal ad server 414 may determine served ad SA4 is to be provided based on ad-related data A2 as described above with respect to FIG. 3B.

The internal ad server 414 may determine served ad SA4 is to be provided based on previously served ad SA3 when an updated version of served ad SA3 is available, to highlight different aspects of the branding experience provided by SA3 (e.g., display different graphical objects, play updated tones as part of MTclient 410's UI), and/or for other reasons SA4 may include a served ad including any or all of the above-described components of a served ad and/or may include commands related to served ads SA3 and/or SA4 (e.g., display splash screen #2 or play ringtone RGT_new_ad).

As shown in FIG. 4, MTproxy 412 sends AdResp 440 to MTclient 410. AdResp 440 may be a copy of AdResp 432 with the ad-related data A2 replaced with contact information c2. In other embodiments, the MTproxy 412 may modify AdResp 432, perhaps by carrying out commands related to served ads SA3 and/or SA4 prior to providing served ad SA4 to MTclient 410 as part of AdResp 440. Contemporaneously with sending AdAlert 420, receiving AdReq 422, and/or sending AdResp 440, the MTproxy 412 may log/store information related to actually-served ads SA3 and/or SA4, perhaps in an ad-request database, such as described above with respect to FIG. 3B.

An MTclient may explicitly request ads as part of other operations, such as submitting a form. For example, an MTclient may submit a form requesting information, coupons, and/or prizes from an advertiser. In response, the MT Network may provide a result of the operation along with a served ad.

FIG. 4 shows MTclient 410 submitting a form via a form-submit command (“FormSub”) 450 to MTproxy 412. FormSub 450 may include contact information c2 and form-related information “F”. Form-related information F may include data about the form (including a copy of or reference to the form) and/or data entered into the form via MTclient 410.

Upon reception of FormSub 450 at MTproxy 412, the MTproxy 412 may be configured to send FormSub 450 to an ad server. The MTproxy 412 may include ad-related data A2 to FormSub 450 before forwarding on the form submission message as FormSub 460. FormSub 460 may include form-related information F from FormSub 450 as well. The ad-related data A2 may be stored and associated with MTclient 410 as described above with respect to FIG. 3.

FIG. 4 shows that MTproxy 412 sends FormSub 460 with ad-related data A2 and form-related information F to external ad server 416. In other scenarios, FormSub 460 may be sent to internal ad server 414. The external ad server 416 may be selected as a destination for FormSub 460based on an association with form-related information F. For example, external ad server 416 may be configured to serve requests based on the form used to provide form-related information F.

FIG. 4 shows external ad server 416 sending form-submit response (“FormSubResp”) 470 to MTproxy 412 in response to FormSub 460. FormSubResp 470 may include ad-related data A2, a form response “FR”, and a served ad “SA5”. The external ad server 416 may determine form response FR based on the form-related information F; e.g., provide requested information/coupons or determine if a requested prize is to be provided. Also or instead, the external ad server 416 may determine served ad SA5 is to be provided based on ad-related data A2 such as described above with respect to FIG. 3B.

SA5 may include a served ad including any or all of the above-described components of served ads and/or may include commands related to served ads SAS and/or form response FR (e.g., display splash screen you_win_prize1, add download1 to FR, print “You won a trip to Bartlett!”, play loser_tone2).

FIG. 4 shows that MTproxy 412 sends FormSubResp 480 to MTclient 410. FormSubResp 480 may be a copy of FormSubResp 470 with the ad-related data A2 replaced with contact information c2. In other embodiments, the MTproxy 412 may modify FormSubResp 470, perhaps by carrying out commands related to served ad SA5 and/or form response FR prior to providing served ad SAS and form response FR to MTclient 410 as part of FormSubResp 480. Contemporaneously with sending FormSubResp 480, MTproxy 412 may log/store information related to actually-served ad SA5, perhaps in an ad-request database, such as described above with respect to FIG. 3B.

An Example Computing Device

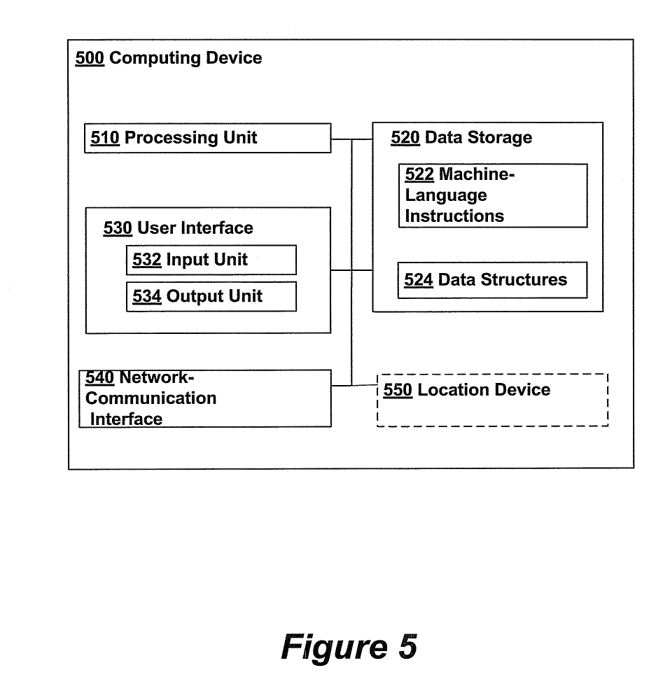

FIG. 5 is a block diagram of an example computing device 500, comprising a processing unit 510, data storage 520, a user interface 530, and a network-communication interface 540, in accordance with embodiments of the invention. A computing device 500 may be a desktop computer, laptop or notebook computer, personal data assistant (PDA), mobile phone, embedded processor, or any similar device that is equipped with a processing unit capable of executing computer instructions to perform at least part of any or all of the herein-described methods and scenarios, scenarios depicted in FIGS. 3A, 3B, and 4, methods 600 and 700, and/or herein-described functionality of an MTserver, MTclient, MTportal, MTproxy, policy server, social-networking website, access network, public network, firewall, enterprise server, internal ad server, external ad server, ad interceptor, and/or network entity.

The processing unit 510 may include one or more central processing units, computer processors, mobile processors, digital signal processors (DSPs), application-specific integrated circuits (ASICs), graphics processing units (GPUs), microprocessors, computer chips, integrated circuits, and similar processing units now known and later developed and may execute machine-language instructions and process data.

The data storage 520 may comprise one or more storage devices. The data storage 520 may include read-only memory (ROM), random access memory (RAM), removable-disk-drive memory, hard-disk memory, magnetic-tape memory, flash memory, and similar storage devices now known and later developed. The data storage 520 may be removable and/or dedicated. The data storage 520 comprises at least enough storage capacity to contain machine-language instructions 522 and data structures 524.

The machine-language instructions 522 and the data structures 524 contained in the data storage 520 include machine-language instructions executable by the processing unit 510 and any storage required, respectively, for at least part of any or all of the herein-described methods and scenarios, including but not limited to scenarios depicted in FIGS. 3A, 3B, and 4, methods 600 and 700, and/or herein-described functionality of an MTserver, MTclient, MTportal, MTproxy, policy server, social-networking website, access network, public network, firewall, enterprise server, internal ad server, external ad server, ad interceptor, and/or network entity. As such, the data storage 520 may include one or more tangible computer-related media configured to store some or all of the machine language instructions described herein.

The user interface 530 may comprise an input unit 532 and/or an output unit 534. The input unit 532 may receive user input from a user of the computing device 500. The input unit 532 may comprise a keyboard, a keypad, a touch screen, a computer mouse, a track ball, a joystick, and/or other similar devices, now known or later developed, capable of receiving user input from a user of the computing device 500.

The output unit 534 may provide output to a user of the computing device 500. The output unit 534 may comprise a visible output device, such as one or more cathode ray tubes (CRT), liquid crystal displays (LCD), light emitting diodes (LEDs), displays using digital light processing (DLP) technology, printers, light bulbs, and/or other similar devices, now known or later developed, capable of displaying graphical, textual, and/or numerical information to a user of computing device 500. The output unit 534 may alternately or additionally comprise one or more aural output devices, such as a speaker, speaker jack, audio output port, audio output device, earphones, and/or other similar devices, now known or later developed, capable of conveying sound and/or audible information to a user of computing device 500.

The network-communication interface 540 is configured to send and receive data and may include a wired-communication interface and/or a wireless-communication interface. The wired-communication interface, if present, may comprise a wire, cable, fiber-optic link or similar physical connection to a wide area network (WAN), a local area network (LAN), one or more public data networks, such as the Internet, one or more private data networks, or any combination of such networks. The wireless-communication interface, if present, may utilize an air interface, such as an IEEE 802.11 (e.g., Wi-Fi) and/or IEEE 802.16 (e.g., WiMax) interface to a WAN, a LAN, one or more public data networks (e.g., the Internet), one or more private data networks, or any combination of public and private data networks.

The computing device 500 may comprise a location device 550. FIG. 5 shows the location device 550 with dashed lines to indicate that the location device 550 is an optional component of the computing device 500. The location device 550 may utilize one or more technologies and techniques to determine a current position, including but not limited to Global Positioning System (GPS), gyroscopes, dead reckoning techniques, magnetic devices such as compasses, landmark comparison processes, lasers (including range finders and ring gyroscopes), and/or radio-frequency waves. Other techniques and technologies for determining the current position of the location device are possible as well. The location device 550 may report the determined current position to the processing unit 510 and/or store the current position in the data storage 520.

An Example Method for Sending Served Ads

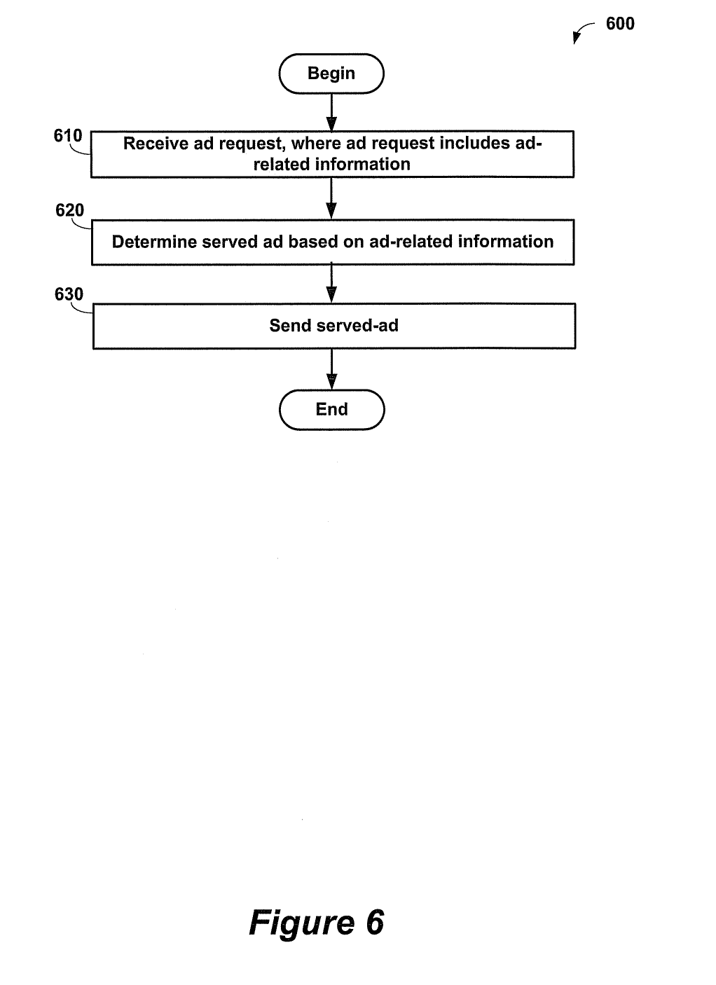

FIG. 6 is a flowchart depicting an example method 600, in accordance with embodiments of the invention.

It should be understood that each block in this flowchart and within other flowcharts presented herein may represent a module, segment, or portion of computer program code, which includes one or more executable instructions for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of the described embodiments.

In particular, methods 600 and/or 700 may be performed by a computing device, such as herein-described computing device 500.

Method 600 begins at block 610. At block 610, an ad request is received. The ad request may be received by a herein-described internal or external ad server from a herein-described MTproxy, using the techniques and messages described above. The ad request may be associated with a trigger. The trigger may be a command, a request for information, and/or an event indication related to an external activity, as described herein. The ad request may be an ad request, such as described above with respect to at least FIGS. 3B and 4. The ad request may include ad-related data, such as the ad-related data described above with respect to at least FIGS. 3A, 3B, and/or 4. The ad request may be received via a network-communication interface.

At block 620, a served ad is determined. The served ad may be determined based on the ad-related data, such as described above with respect to FIGS. 3B and 4. In particular, the served ad may be determined based on location information that is part of the ad-related data ad-related data. The served ad may include graphical data, audio data, textual data, and/or other data. The served ad may be determined based on one or more ad-screening rules and/or conflict resolution as described above with respect to at least FIGS. 2, 3B, and 4.

The ad-screening rules and conflict resolution may include one or more rules associated with one or more advertising categories as described above. Then, when two or more possible served ads are related to multiple advertisers in the same advertising category, ad-screening rules and conflict resolution may be utilized to select a particular advertiser (and from then a particular served ad) from the multiple advertisers in the same advertising category.

In particular, a served advertiser from a plurality of advertisers may be selected based on one or more ad-screening rules and/or conflict resolution. Then, the served ad may be on the served advertiser.

At block 630, the served ad is sent. The served ad may be sent from a herein-described ad server (e.g., an internal ad server or an external ad server) to a herein-described MTproxy, using the techniques and messages described above. The served ad may be sent via a network-communication interface.

After performing the techniques of block 630, method 600 may end.

An Example Method for Sending Served Ads in Response to Triggers

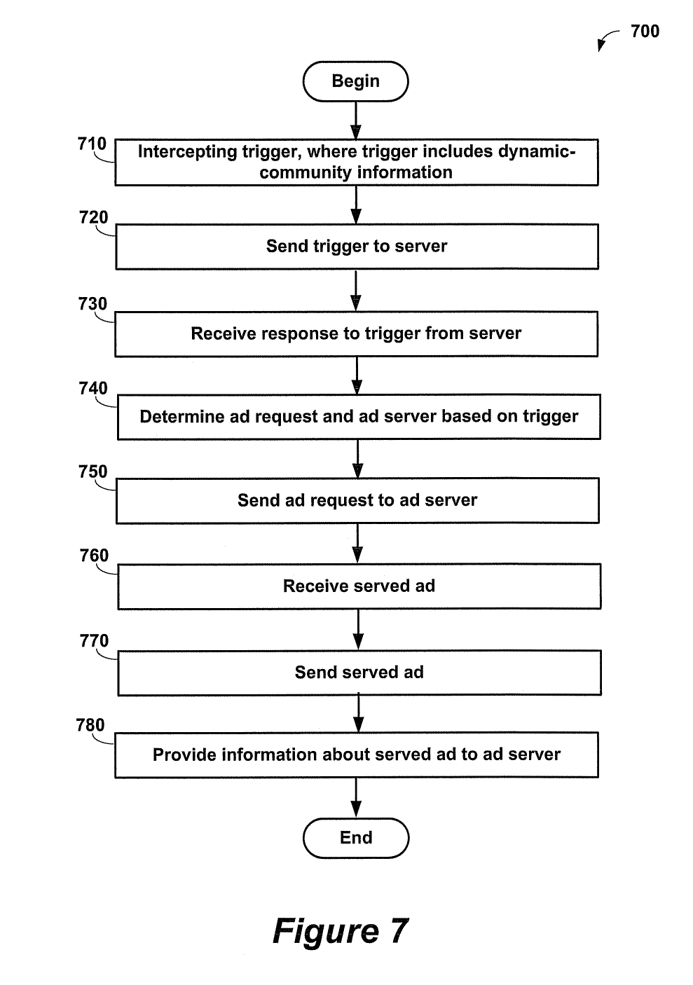

FIG. 7 is a flowchart depicting an example method 700, in accordance with embodiments of the invention. Method 700 may describe providing served ads in response to triggers.

Method 700 may begin at block 710. At block 710, a trigger may be intercepted or otherwise received. The trigger may be a command, a request for information, or an event indication related to an external activity, as described above. The trigger may be intercepted by an MTproxy and/or an ad interceptor as described above with respect to at least FIG. 3B.

The trigger may include or otherwise relate to dynamic-community information, service features, country of origin of the trigger and/or device-related information. Ad-related data may be determined based on the dynamic-community information, as described above with respect to at least FIG. 3A. Thus, the trigger may comprise ad-related data.

At block 720, the trigger may be sent to a server. The trigger may be sent to an MTserver, as described above with respect to at least FIGS. 3B and 4.

At block 730, a response to the trigger may be received. The response to the trigger may be received from an MTserver, as described above with respect to at least FIGS. 3B and 4.

At block 740, an ad request and an ad server may be determined based on the trigger. The ad request and the ad server may be determined based on ad-related data. Also or instead, the ad request and ad server may be determined based on configuration data that includes one or more ad-server addresses. The ad server may be an internal ad server and/or an external ad server. The ad request and the ad server may be determined as described above with respect to at least FIGS. 3B and 4.

At block 750, the ad request may be sent to the ad server. The ad request may be sent to the ad server as described above with respect to at least FIGS. 3B and 4.

At block 760, a served ad may be received. The served ad may be received in response to the ad request. The served ad may be received as described above with respect to at least FIGS. 3B and 4.

At block 770, the served ad may be sent. The served ad may be sent as part of the response to the trigger described above with respect to block 730 and as described above with respect to at least FIG. 3B.

The served ad may be sent in response to an explicit request for an ad from a client, such as an MTclient. The explicit request may be prompted by receipt of an alert request by the client, such as described above with respect to at least FIG. 4. A client may explicitly request ads as part of other operations, such as submitting a form, as described above with respect to at least FIG. 4.

At block 780, information about the served ad, perhaps as an actually-served ad, may be provided to the ad server. In particular, information about the use or interaction with the (actually-served) ad may be provided, along with other information regarding actually-served ads described above with respect to at least FIGS. 3B and 4. The information may be stored in an ad-request database, such as described above with respect to at least FIGS. 2, 3B, and 4. The information may be provided periodically or using some other strategy and may be formatted in a variety of fashions.

After performing the techniques of block 780, method 700 may end.

Exemplary embodiments of the present invention have been described above. Those skilled in the art will understand, however, that changes and modifications may be made to the embodiments described without departing from the true scope and spirit of the present invention, which is defined by the claims. It should be understood, however, that this and other arrangements described in detail herein are provided for purposes of example only and that the invention encompasses all modifications and enhancements within the scope and spirit of the following claims. As such, those skilled in the art will appreciate that other arrangements and other elements (e.g. machines, interfaces, functions, orders, and groupings of functions, etc.) can be used instead, and some elements may be omitted altogether.

Further, many of the elements described herein are functional entities that may be implemented as discrete or distributed components or in conjunction with other components, in any suitable combination and location, and as any suitable combination of hardware, firmware, and/or software.

We claim:

1. A method to be performed by a computing device, the method comprising:
receiving a trigger, wherein the trigger comprises ad-related data;
sending an ad request to an ad server based on the trigger;
receiving a served ad in response to the ad request; and
sending the served ad.

2. The method of claim 1, wherein the trigger is a request for information.

3. The method of claim 1, wherein the trigger is an event notification.

4. The method of claim 1, wherein the trigger comprises information about service features, country of origin of the trigger, device-related information, or a combination thereof.

5. The method of claim 1, wherein the ad-related data comprises user-selectable information related to an advertiser.

6. The method of claim 1, wherein the ad-related data comprises social-networking information.

7. The method of claim 6, wherein the social-networking information comprises social-networking information based on one or more messages.

8. The method of claim 1, wherein sending an ad request comprises sending an ad request contextually based on a dynamic-community change.

9. The method of claim 1, further comprising:
responsive to sending the served ad, storing information about the sent served ad in an ad-request database.

10. An apparatus, comprising:
a processing unit;
a network-communication interface;
data storage; and
machine-language instructions, stored in the data storage, executable by the processing unit to perform functions, the functions comprising:
receiving an ad request associated with a trigger via the network-communication interface, wherein the ad request comprises ad-related data,
determining a served ad based on the ad-related data, and
sending the served ad via the network-communication interface.

11. The apparatus of claim 10, wherein the served ad comprises graphical data, audio data, textual data, and other data.

12. The apparatus of claim 10, wherein the ad-related data further comprises location information and wherein determining the served ad further comprises determining the served ad based on the location information.

13. The apparatus of claim 10, wherein the data storage is further configurable to store one or more ad-screening rules, and wherein determining the served ad comprises determining the served ad based on the one or more ad-screening rules.

14. The apparatus of claim 13, wherein determining the served ad based on the one or more ad-screening rules comprises:
selecting a served advertiser from a plurality of advertisers based on the one or more ad-screening rules; and
determining the served ad based on the served advertiser.

15. The apparatus of claim 13, wherein the one or more ad-screening rules comprises one or more ad-screening rules associated with one or more advertising categories.

16. The apparatus of claim 15, wherein at least two advertisers in a plurality of advertisers are associated with a given advertising category, and wherein determining the served ad based on the one or more ad-screening rules comprises:
performing conflict resolution to select one selected advertiser of the at least two advertisers; and
selecting an ad from the one selected advertiser as the served ad.

17. A method to be performed by a computing device, the method comprising:
intercepting a trigger, the trigger comprising dynamic-community information;
sending the trigger to a server;
receiving a response to the trigger from the server;
determining an ad request and an ad server based on the trigger;
sending the ad request to the ad server;
in response to the ad request, receiving a served ad; and
sending the response to the trigger, wherein the response to the trigger comprises the served ad.

18. The method of claim 17, wherein the ad server is an internal ad server.

19. The method of claim 17, wherein determining the ad request and ad server comprises determining the ad server based on configuration data, the configuration data comprising one or more ad-server addresses.

20. The method of claim 17, further comprising:
responsive to sending the served ad, providing data about the served ad to the ad server.
